(19) United States
(12) Patent Application Publication
(10) Pub. No.: US 2016/0215534 A1
(43) Pub. Date: Jul. 28, 2016

(54) VEHICLE DOOR LATCH FOR PREVENTING LOCKING

(71) Applicants: HYUNDAI MOTOR COMPANY, Seoul (KR); Kia Motors Corporation, Seoul (KR); HYUNDAI MOTOR INDIA ENGINEERING PVT, LTD., Hyderbad (IN)

(72) Inventors: Ch P K N Varma RUDRARAJU, Hyderabad-49 (IN); Youn Seob KIM, Hwaseong-si (KR)

(73) Assignees: HYUNDAI MOTOR COMPANY, Seoul (KR); KIA MOTORS CORPORATION, Seoul (KR); HYUNDAI MOTOR INDIA ENGINEERING PVT, LTD., Hyderbad (IN)

(21) Appl. No.: 14/689,930

(22) Filed: Apr. 17, 2015

(30) Foreign Application Priority Data
Jan. 22, 2015 (IN) 198/DEL/2015

(51) Int. Cl. E05B 85/20

(52) U.S. Cl. CPC E05B 85/20

(57) ABSTRACT

A vehicle door latch for preventing locking includes a locking lever rotating on a first shaft. A safety knob lever has one end facing the locking lever and restricts the rotation of the locking lever and movement of a door opening unit by engaging with one end of the locking lever. The safety knob lever locks a vehicle door or unlocks the door by disengaging. A latch gear is disposed on the first shaft, which opens/closes the door by engaging with or disengaging from a striker in accordance with the movement of the door opening unit when an inside handle and an outside handle move. An elastic member is disposed on the latch gear. The elastic member is in contact with the locking lever and provides an elastic force to the locking lever when the latch gear rotates in a counterclockwise direction.

### CROSS-REFERENCE TO RELATED APPLICATION

This application claims under 35 U.S.C. §119(a) the benefit of priority to Indian Patent Application No. 198/DEL/2015 filed on Jan. 22, 2015, the entire contents of which are incorporated herein by reference.

### TECHNICAL FIELD

The present disclosure relates to a vehicle door latch for preventing locking. More particularly, it relates to a vehicle door latch for preventing locking which includes an elastic member in order to prevent a vehicle equipped with a mechanical lock from being locked unexpectedly.

### BACKGROUND

In vehicle door locking devices, a latch gear restricting a striker fixed to a car body, a pawl restricting the latch gear, and an inside handle lever connected with a pawl lever are mounted on a base plate.

An outside handle lever, which turns the pawl lever when an outside handle is opened, is fitted on a shaft on which the pawl lever is fitted, so it releases the latch gear by turning the pawl lever and the pawl when the outside handle lever is opened, thereby opening a door.

The outside lever is restricted by turning of a locking lever disposed on an inner side of a case for an antitheft function in the door locking devices, and a safety knob lever is provided to restrict the locking lever by engaging with or disengaging from the locking lever. The safety knob lever restricts the locking lever by engaging with one end of the locking lever in accordance with setting of a safety knob (locking knob) inside a door panel, thereby locking the door of a vehicle.

However, when a user turns the locking lever forward by operating the locking knob when the door is opened, the door locking device becomes locked, and if the user closes the door, the door becomes unexpectedly locked.

When the user gets out of the vehicle with a key, he/she can simply unlock the door by inserting the key into a key cylinder, but when the user leaves the key in the vehicle, he/she needs an external assistance to unlock the door locking device.

There is an anti-panic mechanism as a door latch device, but it does not prevent a door locking device from being unexpectedly locked with a simple elastic member. Further, it does not provide a device for preventing unexpected locking in a mechanical door latch system.

The above information disclosed in this Background section is only for enhancement of understanding of the background of the invention, and therefore, it may contain information that does not form the prior art that is already known in this country to a person of ordinary skill in the art.

### SUMMARY OF THE DISCLOSURE

The present disclosure has been made in an effort to solve the above-described problems associated with the prior art.

An aspect of the present inventive concept provides an elastic member for automatically unlocking a door of a vehicle even when the door is opened and locked, which is disposed on a surface of a locking lever to prevent unexpected locking of the vehicle, and an elastic force of the elastic member being in contact with the locking lever is larger than an engagement force of a safety knob lever and the locking lever.

According to an exemplary embodiment of the present inventive concept, a vehicle door latch for preventing locking includes a locking lever rotating on a first shaft. A safety knob lever has one end facing the locking lever, restricts the rotation of the locking lever and movement of a door opening unit by engaging with one end of the locking lever, and locks/unlocks a vehicle door by engaging/disengaging. A latch gear is disposed on the first shaft and opens/closes the door by engaging with or disengaging from a striker 42 in accordance with the movement of the door opening unit when an inside handle and an outside handle move. An elastic member is disposed on the locking gear, comes in contact with the locking lever, and provides an elastic force to the latch gear when the latch gear rotates in a counterclockwise direction. The elastic member is spaced apart from the locking lever when the vehicle door is closed, and the elastic member comes in contact with the locking lever. The elastic member provides an elastic force to the locking lever, and disengages the one end of the locking lever engaged with the safety knob lever, when the latch gear rotates in the counterclockwise direction and the vehicle door is opened.

The door opening unit may include a connecting lever of which one end is connected with the locking lever and another end moves in a slot of an outside handle lever turnably connected with the outside handle. The connecting lever selectively restricts motion of the door opening unit by the locking lever and the outside handle lever.

The door opening unit may further include a pawl disposed on a second shaft with the outside handle lever, operated with the outside handle lever, and contacting one end of the latch gear such that the latch gear rotates A pawl lever is disposed on the second shaft and operated with the outside handle lever. The pawl lever has one end connected with an inside handle lever connected with the inside handle in the vehicle and operates with the pawl.

In the safety knob lever, a fixed portion of the safety knob lever facing the locking lever has a U-shape, and a spring member is further disposed inside the fixed portion facing the locking lever to be selectively fitted to the one end of the locking lever.

A second spring, which returns the outside handle lever, the pawl, and the pawl lever by an elastic force, is disposed on the second shaft.

In the vehicle door latch for preventing locking of a vehicle according to the present disclosure, when a vehicle door is opened, the latch gear rotates backward (counterclockwise direction) and the elastic member is in contact with the rotating latch gear, such that the vehicle door cannot be locked when the door is opened.

According to the vehicle door latch, it is possible to prevent the door from unexpectedly locking by a user when operating a locking knob and the door is opened, thus saving time and cost for unlocking the unexpectedly locked door.

Further, since a mechanical door latch according to the present disclosure does not require an electric component, it is possible to achieve a door latch separately at a low cost.

Other aspects and exemplary embodiments of the inventive concept are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present inventive concept.

FIG. 1 is a view showing a configuration using a mechanical locking device in a related art.

FIG. 2A is a view showing the positions of a locking lever and a first spring member on a shaft when a door is opened in a related art.

FIG. 2B is a view showing contact between a locking lever and an elastic member when a door of a vehicle starts to be opened according to an embodiment of the present inventive concept.

FIG. 3 is a view showing a configuration in which the locking lever and the elastic member are operated at a predetermined distance from each other when a door of a vehicle is closed according to an embodiment of the present inventive concept.

FIG. 4 is a side view showing contact between the locking lever and the elastic member when a door of a vehicle starts to be opened according to an embodiment of the present inventive concept.

FIG. 5A is a view showing contact between the locking lever and the elastic member when a door of a vehicle starts to be opened according to an embodiment of the present inventive concept.

FIG. 5B is a view showing the locking lever and the elastic member that have been turned when a door of a vehicle is opened according to an embodiment of the present inventive concept.

FIG. 5C is a view showing unlocking by the elastic member providing an elastic force when a locking lever is locked forward and when a door of a vehicle is opened according to an embodiment of the present inventive concept.

It should be understood that the appended drawings are not necessarily to scale, presenting a somewhat simplified representation of various features illustrative of the basic principles of the inventive concept. The specific design features of the present inventive concept as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present inventive concept, examples of which are illustrated in the accompanying drawings and described below. While the inventive concept will be described in conjunction with exemplary embodiments, it will be understood that present description is not intended to limit the invention to those exemplary embodiments. On the contrary, the inventive concept is intended to cover not only the exemplary embodiments, but also various alternatives, modifications, equivalents, and other embodiments, which may be included within the spirit and scope of the inventive concept as defined by the appended claims.

### Examples

The following examples illustrate the disclosure and are not intended to limit the same.

Hereinafter, exemplary embodiments of the present inventive concept will be described more fully with reference to the accompanying drawings for those skilled in the art to easily implement the present disclosure.

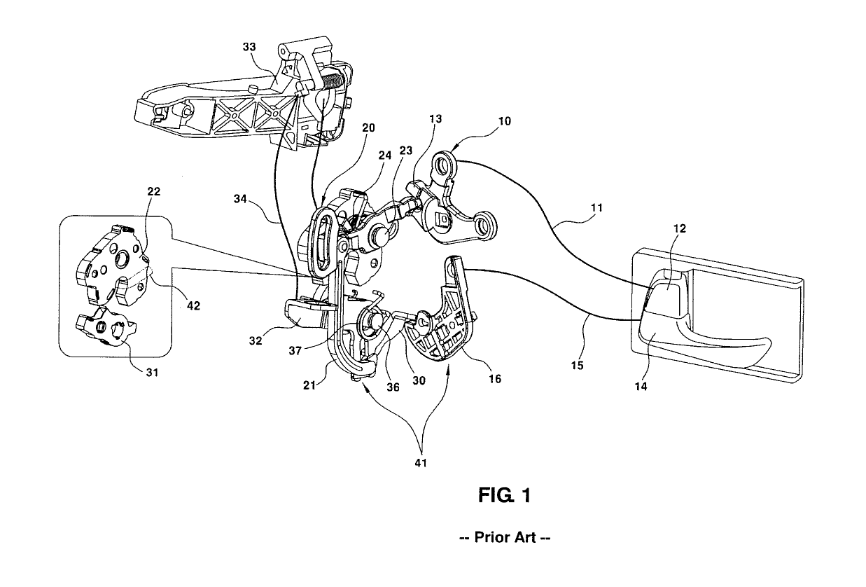

FIG. 1 shows a configuration of mechanical door latch according to a related art.

In general, a door latch includes a safety knob 12 that sets door locking of a vehicle and a safety knob lever 10 that is connected to a safety knob cable 11. The safety knob lever 10 has one end connected with a locking lever 20 and another end connected with the safety knob 12 through a cable. The one end of the safety knob lever 10 connected with the locking lever 20 has a fixing portion 13 that can be selectively engaged with and disengaged from the locking lever 20. That is, when the safety knob 12 is set to be locked, the safety knob lever 10 turns backward (counterclockwise) and is engaged with one end of the locking lever 20. The fixing portion 13 of the safety knob lever 10 may have a U-shape, and one end of the locking lever 20 is engaged with an inner side of the U-shape. The inner side of the U-shape of the fixing portion 13 may provide an elastic force, with which the locking lever 20 is engaged.

The locking lever 20 connected with the safety knob lever 10 can rotate by a first shaft 23. The door latch of the related art includes a latch gear 22 disposed on the first shaft 23 and opens/closes the door in accordance with operation of an inside handle 14 and an outside handle 33. A first spring 24 is disposed on a top of the locking lever 20 and the latch gear 22 and provides an elastic force for returning the locking lever 20 and the latch gear 22.

The door latch further includes a door opening unit 41 that turns the latch gear 22 in accordance with operation of the inside handle 14 and the outside handle 33. The door opening unit 41 is connected with the locking lever 20 and includes a connecting lever 21. Another end of the locking lever 20 can move in a slot 35 of an outside handle lever 32 turnably connected with the outside handle 33. The connecting lever 21 connects the door opening unit 41 with the locking lever 20. That is, when the locking lever 20 is locked, it is engaged with the safety knob lever 10 and its motion is restricted, and the door opening unit 41 is also restricted by the connecting lever 21 connected with the locking lever 20. Accordingly, when the door is locked, rotation of the latch gear 22 through the door opening unit 41 is restricted.

The connecting lever 21 can move in a certain restriction in the slot 35 of the outside handle lever 32. The slot 35 may have an oblong shape and may have an opening at one side. Accordingly, when unlocking the door, the locking lever 20 is turned backward (counterclockwise) at a predetermined angle, such that the connecting lever 21 is spaced apart at a predetermined distance in the slot 35 to obtain degrees of freedom. The door opening unit 41 can open the door through the rotation of the latch gear 22 due to the distance in the spaced slot 35.

The outside handle lever 32 is connected with the outside handle 33 through an outside handle rod 34. Accordingly, the outside handle lever 32 is operated by the outside handle 33 and can turn about a second shaft 36. The outside handle lever 32 on the second shaft 36 has a pawl 31 connected such that the latch gear 22 rotates in contact with one end of the latch gear 22 on the same shaft. Further, it includes a second spring 37 on the second shaft 36, and when components on the second shaft 36 are turned, the second spring 37 provides a returning force.

Further, a pawl lever 30 is provided, of which one end is connected with the inside handle lever 16 connected with the inside handle 14 in the vehicle and another end is capable of turning the pawl 31 in contact with the pawl 31. The inside handle 14 and the inside handle lever 16 are connected by an inside handle cable 15.

When a user opens the vehicle door through the outside handle 33 outside the vehicle, the outside handle lever 32 connected with the outside handle 33 of the door latch is turned forward and the pawl lever 30 operating with the outside handle lever 32 is also turned in the same direction as the outside handle lever 32. Further, the pawl 31 on the second shaft 36 is turned in the same direction as the components on the same shaft and causes the latch gear 22 being in contact with one end of the pawl 31 to be rotated backward (counterclockwise). The pawl 31 and the pawl lever 30 may be turned forward, and the latch gear 22 connected with the pawl 31 may be turned backward.

Further, when the user opens the door by operating the inside handle 14 of the vehicle, the pawl lever 30 being in contact with the inside handle lever 16 is turned and the latch gear 22 rotates backward (counterclockwise).

As described above, the door can be opened by the operation of the inside handle 14 and the outside handle 33, that is, the door can be opened by backward rotation of the latch gear 22 through the operation of the door opening unit 41.

When the vehicle is set to be locked, the safety knob 12 is operated, that is, the safety knob lever 10 moves through the safety knob cable 11 connected with the safety knob lever 10. The safety knob lever 10 may be turned backward (counterclockwise), such that one end of the locking lever 20 is restricted and motion of the locking lever 20 is restricted.

As described above, as the motion of the locking lever 20 is restricted, motion of the door opening unit 41 connected with the locking lever 20 through a connecting rod is restricted. Further, when a vehicle is set to be locked, backward (counterclockwise) turning of the locking lever 20 is restricted.

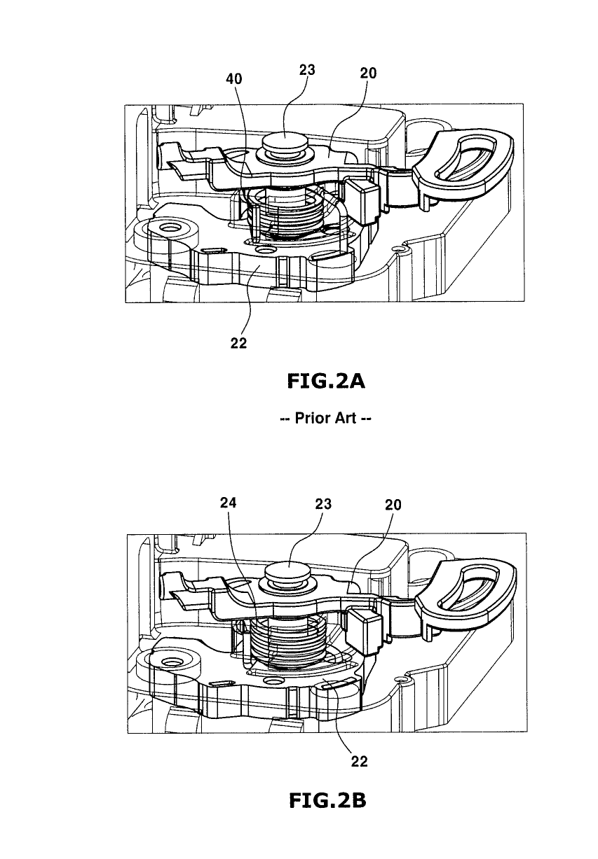

FIG. 2A shows a configuration of the first shaft 23 in the related art.

As shown in FIG. 2A, the locking lever 20 and the latch gear 22 rotate by the first shaft 23. Further, the first spring 24 on a top of the locking lever 20 and the latch gear 22 provides an elastic force in an opposite direction to a rotational direction of the latch gear 22, such that it returns the latch gear 22 to a previous position.

When the vehicle door is opened, the latch gear 22 rotates backward. As shown in FIG. 2A, the first spring 24 is not in contact with the locking lever 20, and thus, when the latch gear 22 rotates, it does not influence the locking lever 20.

FIG. 2B shows a configuration of the first shaft 23 of the present disclosure, in which the elastic member 40 is coupled to the top of the locking lever 20 and the latch gear 22.

When the vehicle door is opened, the latch gear 22 rotates backward, and as shown in FIG. 2B, the elastic member 40 has a surface being contact with the locking lever 20 due to the backward rotation of the latch gear 22. When the door is opened, as described above, the latch gear 22 rotates backward at a predetermined angle, such that the elastic member 40 provides an elastic force backward in contact with the locking lever 20. As described above, since the locking lever 20 being in contact with the elastic member 40 is disposed at the middle of the movement distance of the latch gear 22 for opening a door, the locking lever 20 receives the backward elastic force from the elastic member 40.

In the embodiment of the present inventive concept, the elastic member 40 may be disposed on the first spring 24. Or, the elastic member 40 may be a leaf spring or a coil spring independent from the first spring 24.

Accordingly, even though the vehicle door is opened and the locking lever 20 is locked by engaging with the safety knob lever 10, a predetermined elastic force is applied to the locking lever 20, that is, an elastic force larger than the engagement force of the locking lever 20 is provided. When a vehicle is set to be locked as the door is opened, the engaging force is automatically removed since the elastic force of the elastic member 40 is larger than the engagement force of the locking lever 20.

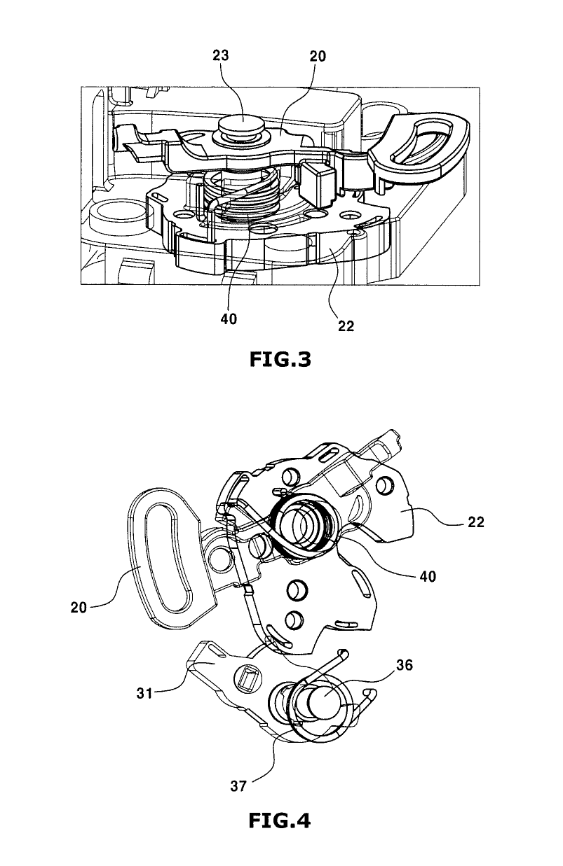

FIG. 3 shows the locking lever 20 the latch gear 22, and the elastic member 40, when the vehicle door is closed.

As shown in FIG. 3, a position of the elastic member 40 is determined in accordance with a rotational distance of the latch gear 22, thus when the door is closed, the elastic member 40 maintains to be spaced apart at a predetermined distance from the lacking lever 20. Accordingly, when the vehicle door is set to be locked through the safety knob 12, the door of the vehicle can be locked without the elastic force of the elastic member 40.

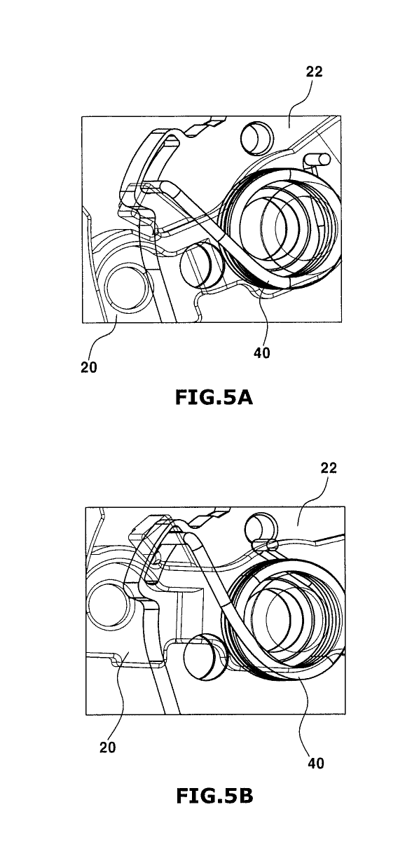

FIG. 4 is a side view showing a vehicle door latch for preventing locking of a vehicle according to the present disclosure. The door latch includes the elastic member 40 connected with the latch gear 22 and the pawl 31 connected with one end of the latch gear 22. The elastic member includes the locking lever 20 disposed at a middle of a movement distance of the latch gear 22. Thus, when the vehicle door is opened, the latch gear 22 rotates backward and the elastic member 40 has the same turning distance in combination with the latch gear 22. The elastic member 40 comes in contact with the locking lever 20 during the rotation and continues tuning while the latch gear 22 finishes rotating in order to open a door and to provide a predetermined elastic force to the locking lever 20.

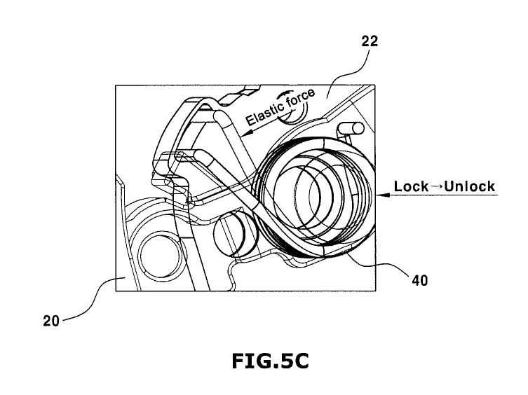

FIGS. 5A and 5B are views showing operation of the vehicle door latch for preventing locking of a vehicle according to the present disclosure.

FIG. 5A shows a point of time when the elastic member 40 comes in contact with the locking lever 20, with rotation of the latch gear 22, when the vehicle door starts opening. The locking lever 20 is disposed at the middle of the movement distance when the latch gear 22 is rotated.

FIG. 5B shows a configuration in which the vehicle door completes an opening operation. When the latch gear 22 fully rotates to open the door, the elastic member 40 being in contact with the locking lever 20 at the middle of the movement distance when the latch gear 22 rotates continues providing an elastic force. That is, the elastic member 40 and the latch gear 22 rotate together and the elastic member 40 provides the elastic force by a rotational force after the elastic member 40 and the latch gear 22 are brought in contact with each other to turn the locking lever 20 backward.

FIG. 5C shows an operation for unlocking, when a vehicle is set to be locked by the safety knob 12 of the vehicle.

When the latch gear 22 fully rotates and a door of a vehicle is opened, the elastic member 40 turned with the latch gear 22 provides an elastic force to the locking lever 20 so that the locking lever 20 can turn backward. Accordingly, after the door is opened, even if the door locking device of the vehicle is set, the elastic force applied to the locking lever 20 is larger than the engagement force of the locking lever 20 due to the safety knob lever 10, thus preventing the vehicle door from automatically locking.

The inventive concept has been described in detail with reference to exemplary embodiments thereof. However, it will be appreciated by those skilled in the art that changes may be made in these embodiments without departing from the principles and spirit of the disclosure, the scope of which is defined in the appended claims and their equivalents.

What is claimed is:

1. A vehicle door latch for preventing locking, comprising:
a locking lever rotating on a first shaft;
a safety knob lever having one end facing the locking lever, restricting the rotation of the locking lever and movement of a door opening unit by engaging with one end of the locking lever, and locking or unlocking a vehicle door by engaging with or disengaging from the locking lever;
a latch gear disposed on the first shaft, the latch gear opening/closing the door by engaging with or disengaging from a striker in accordance with the movement of the door opening unit when an inside handle and an outside handle move; and
an elastic member disposed on the latch gear, the elastic member contacting the locking lever and providing an elastic force to the locking lever when the latch gear rotates in a counterclockwise direction,
wherein the elastic member is spaced apart from the locking lever when the door is closed, and when the latch gear rotates in the counterclockwise direction and the door is opened, the elastic member comes in contact with the locking lever, provides the elastic force to the locking lever, and disengages the one end of the locking lever which is engaged with the safety knob lever.

2. The vehicle door latch of claim 1, wherein the door opening unit includes:
a connecting lever of which one end is connected with the locking lever and another end moves in a slot of an outside handle lever rotatably connected with the outside handle, and
wherein the connecting lever selectively restricts the movement of the door opening unit by the locking lever and the outside handle lever.

3. The vehicle door latch of claim 2, wherein the door opening unit further includes:
a pawl disposed on a second shaft with the outside handle lever, the pawl operating with the outside handle lever and contacting one end of the latch gear such that the latch gear rotates; and
a pawl lever disposed on the second shaft, the pawl lever operating the outside handle lever, having one end connected with an inside handle lever connected with the inside handle in the vehicle, and operating with the pawl.

4. The vehicle door latch of claim 1, wherein the safety knob lever includes:
a fixed portion of the safety knob lever facing the locking lever having a U-shape; and
a spring member disposed inside the fixed portion facing the locking lever to be selectively fitted to the one end of the locking lever.

5. The vehicle door latch of claim 3, wherein the second shaft includes a second spring returning the outside handle lever, the pawl, and the pawl lever by an elastic force.
